(19) United States
(12) Patent Application Publication
(10) Pub. No.: US 2006/0145846 A1
(43) Pub. Date: Jul. 6, 2006

(54) Container assembly

(76) Inventors: Johannes Hendrik Vos, Melkos Strand (ZA); Etienne Vos, Johannesburg (ZA)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/530,671

(22) PCT Filed: Aug. 21, 2003
(86) PCT No.: PCT/ZA03/00121

§ 371 Date: Jan. 7, 2006

(51) Int. Cl. G08B 13/08

(52) U.S. Cl. 340/545.6

(57) ABSTRACT

This invention relates to a container assembly and more particularly, but not exclusively, to a container assembly for holding a prize inside a container. The container assembly includes a container body (2) defining a main compartment. A hollow insert (8) is located in the main compartment (4) to form a secondary compartment (5) within the main compartment (4). A liquid is sealed inside the secordary compartment (5) and the container body (2) has a lid (3) closing the main compartment (4).

### FIELD OF THE INVENTION

This invention relates to a container assembly and more particularly, but not exclusively, to a container assembly for holding a prize inside a container.

### BACKGROUND TO THE INVENTION

U.S. Pat. No. 5,099,232 entitled “Prize holding container assemblies” in the name of James P Howes discloses a container for holding a prize. By providing an audible and/or visual prize related message delivery system cooperatingly associated with a container shell, which is closed in a conventional manner, a container assembly is achieved for randomly distributing prize awards to consumers in association with any product, without fear of consumer detection of the prize bearing containers. The container assembly may incorporate the actual product along with the prize related message delivery system or may comprise a simulated product container bearing the prize related message delivery system without the actual product. In both embodiments, the container assembly is completely indistinguishable from non-prize bearing, product-holding containers.

### OBJECT OF THE INVENTION

It is an object of the invention to provide a container assembly of the type described above.

### SUMMARY OF THE INVENTION

In accordance with the invention there is provided a container assembly comprising a container body defining a main compartment; a hollow insert located in the main compartment to form a secondary compartment within the main compartment; the secondary compartment having a closure means for sealing a liquid therein; and the container body having a lid to close the main compartment.

There is provided for the insert to have locating means to locate it in the main compartment.

Further features of the invention provide for the main compartment to include a sleeve insert; for the sleeve insert to be a split or two part sleeve for the sleeve parts to be resiliently deformable; for the sleeve parts to terminate in inwardly axially extending lips; and alternatively, for the sleeve parts to have screw thread formations extending from an inside surface of each part.

Still further features of the invention provide for the insert to be cylindrical; for its locating means to be an outer screw thread for engagement with the screw thread formations on the two part sleeve; alternatively, for the insert to have two cylindrical sections, a first section having a larger diameter than a second section; and for the insert to have a cylindrical operatively lower hollow section and a frusto conical operatively upper hollow section; and for the first cylindrical section of the insert to be its engagement means for frictional engagement with the inwardly extending lip formations in which each part of the two part sleeve terminates.

There is also provided for the container lid to have a circumferentially extending slot for engagement with an upper edge of the container body.

The upper edge of the container body is a right-circular upwardly extending rim section for engagement with the complementary shaped slot in the lid.

There is provided for the lid to include notification means.

A yet further feature of the invention provides for the notification means to be a sticker located under the lid.

There is provided for the closure means of the insert to be a disc.

These and other features of the invention are described in more detail below.

### BRIEF DESCRIPTION OF THE DRAWINGS

Preferred embodiments of the invention are described below, by way of example only, and with reference to the accompanying drawings in which:

FIG. 1 shows an exploded view of a first embodiment of a container assembly;

FIG. 2 shows a cross-sectional side view of the container assembly of FIG. 1;

FIG. 3 shows a perspective view of the container assembly of FIGS. 1 and 2;

FIG. 4 shows an exploded view of a second embodiment of a container assembly;

FIG. 5 shows a partly exploded view of the container assembly of FIG. 4;

FIG. 6 shows a cross-sectional side view of the container assembly of FIGS. 4 and 5;

FIG. 7 shows a lid for the container assembly of FIGS. 4, 5 and 6 at a stage during its production;

FIG. 8 shows a part cross sectional view of an outer edge of the lid of FIG. 7 bent and the lid attached on a top of a container body of the container assembly of FIGS. 4, 5 and 6;

FIG. 9 shows a partial view of a top end of the container body of FIGS. 4, 5 and 6 at a stage during its production; and

FIG. 10 shows the view of FIG. 9 including broken lines along which a top edge of the container body is cut.

### DETAILED DESCRIPTION OF THE DRAWINGS

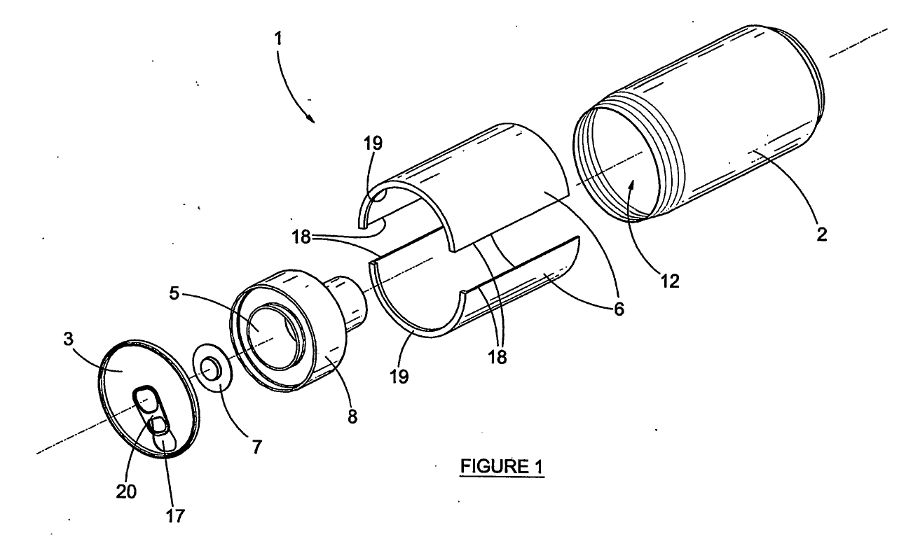

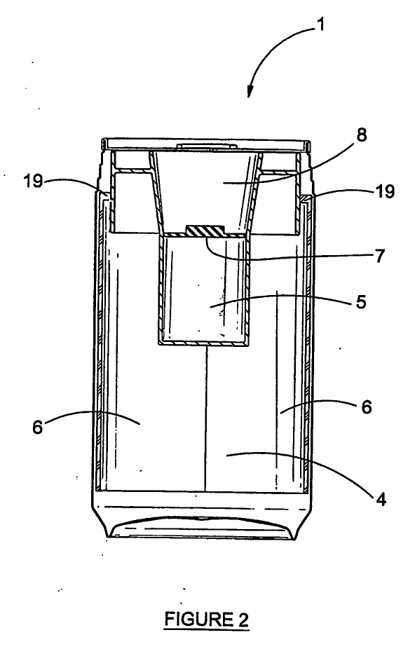

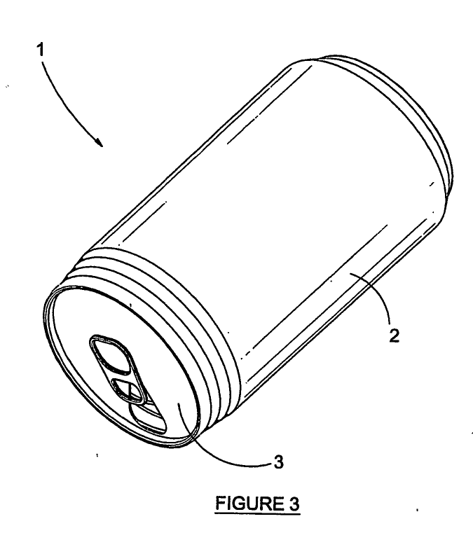

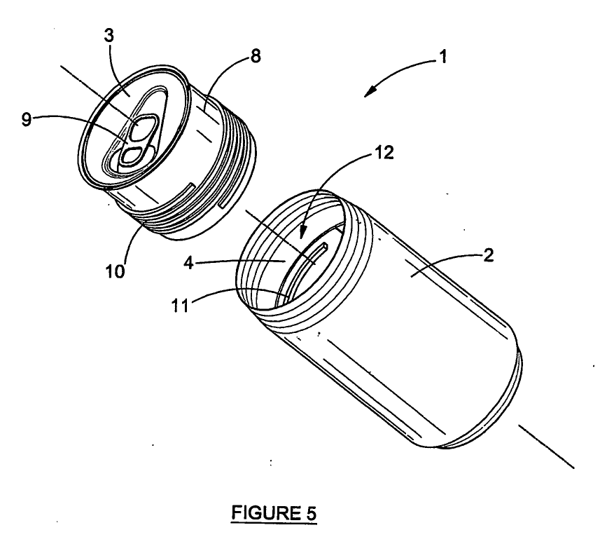

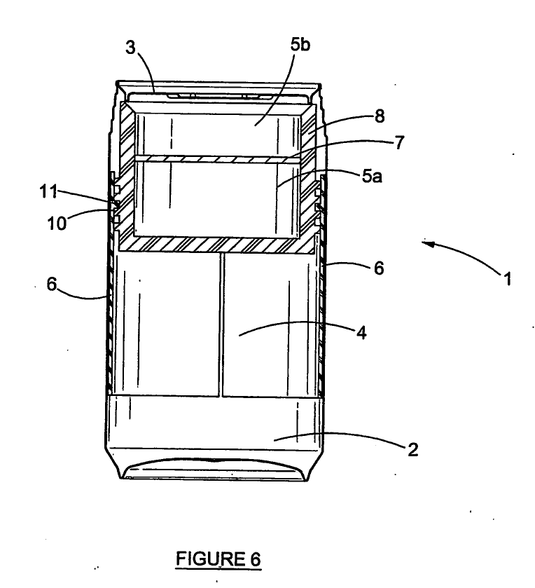

With reference to FIGS. 1 to 6, in which like features are indicated by like numerals, a container assembly is generally indicated by reference numeral 1.

The container assembly includes a container body 2 defining a main compartment 4 and having an insert 8 located in the main compartment 4. The insert 8 is a hollow generally cylindrical body locatable in a upper end of the body 2. The insert 8 defines a secondary compartment 5 within the main compartment. The secondary compartment 5 includes a partition 7 for sealing a liquid in a lower part of the secondary compartment, as is more fully described below.

The container body includes a container lid 3 for sealing the insert 8 in the main compartment 4. The lid 3 includes a tab 18 to provide downward leverage, when lifted, at a rear end, away from the lid on a break-out section 17 in the lid, as is known in the art, to partly tear the break-out section 17 from the lid 3 along a line of weakness and hinge it downwards into the container along a line where a line of weakness is not provided.

A two-part sleeve 6 is inserted inside the main compartment. The sleeve is cut in a plane through its axis so that a two part sleeve is formed to facilitate easy insertion thereof in the main compartment 4. - The outer diameter of the composite sleeve has a larger diameter than the inside diameter of a mouth 12 of the container body 2. The parts are resilient so that they can be inserted through the mouth of the body 2 by bending opposing axially extending edges 18 towards each other. One part of the sleeve is inserted in the main compartment and located against the side of the main compartment whereafter the other part of the sleeve is inserted and forced against the side of the main compartment opposite the first part so that its edges 18 clips past and locates against the edges 18 of the first part, to form a composite sleeve. When the insert 8 is located within the main compartment 4 it abuts upper inwardly axially extending lips 19 in which the two part sleeve 6 of FIGS. 1, 2 and 3 terminates, thereby securing the sleeves inside the main compartment 4.

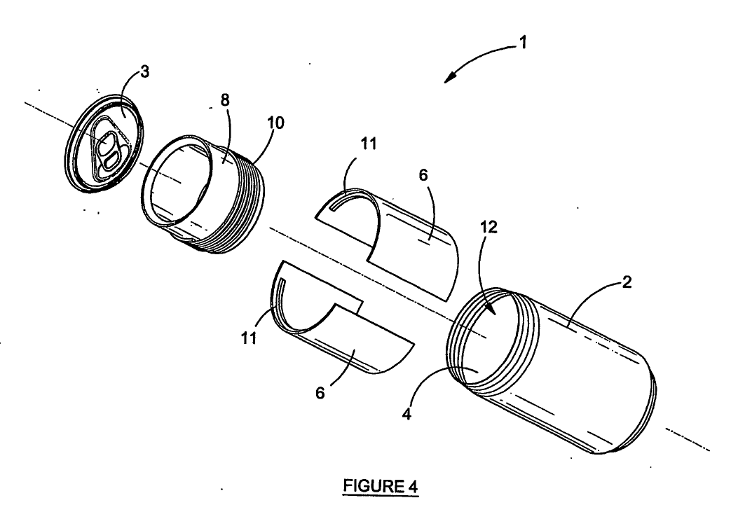

In the case of the embodiment shown in FIGS. 4,5 and 6, the insert 8 has an outer screw thread 10 which screws onto screw thread formations 11 which are complimentary shaped lip formations extending axially inwardly from an inner surface near an upper end of each sleeve part 6. The lip formations 11 are complimentary single elongate protrusions and do not form complete screw-threading.

The lid 3 shown in FIGS. 1, 2 and 3 is press fit on the mouth of the container body 2. The lid may, alternatively be screw threaded to engage complementary screw threads in the mouth of the container body.

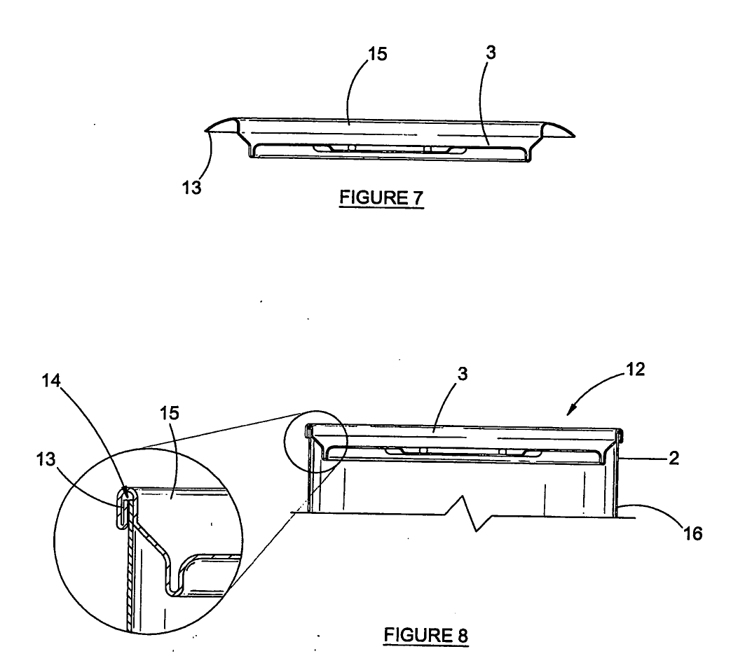

FIG. 7 shows the lid as it comes off a production line at a certain stage of production of a can. The outer circumferential edge of the lid is folded back over itself to form a double wall on one side of a slot 14, formed between the double folded edge, an upwardly extending lip 15 of the lid 3 and a carved section between the lip 15 and double folded edge.

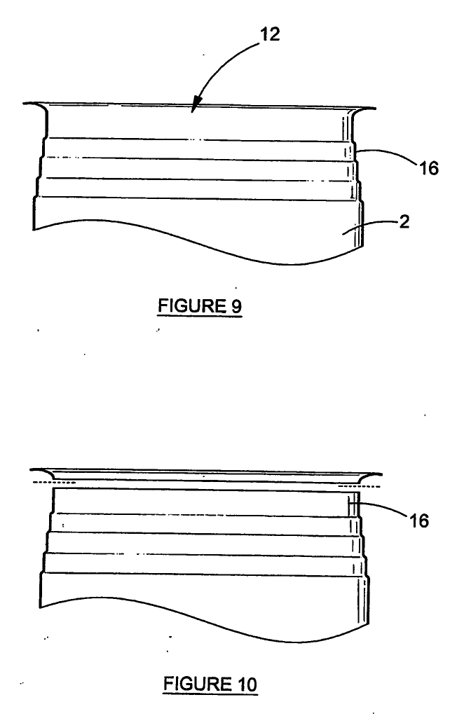

FIG. 9 shows a top or mouth of the container body 2 as it comes off a production line at a certain stage of production of a prior art can. The top edge around the mouth of the container body is cut along the broken lines shown in FIG. 10 so that the mouth terminates in an upright right-circular, flat rim section 16.

The upright rim-section 16 is now inserted into the slot 14. Glue may be applied before insertion to secure the lid 3 on the container body 2. Alternatively, the lid is only press-fit onto the rim of the container body to allow for the manual removal thereof.

A notification means, to notify a user that a prize is located in the main compartment, is provided in the form of a sticker on an upper surface of the partition 7. The sticker includes a notification that a prize is located in the main compartment and instructions as to how to open the container assembly to get to the prize.

In use, the outside of the container body 2 has markings similar to those of a product to be distributed. For example, the markings may resemble that of a well-known beverage so that the container assembly is indistinguishable from the normal product containers. A prize may be located in the main compartment 4 and a liquid such as water is sealed in the secondary compartment 5 under the partition 7.

One purpose of the secondary compartment is to receive a fluid such as water underneath the partition so that the container 1, together with the fluid in the secondary compartment 5 and the prize located in the main compartment 4, matches the weight of the normal product sold in a similar container.

The purpose of the sleeve 6 is to strengthen the container so that the container feels as if the normal product is located therein. Movement or shaking of the container assembly 1 causes the fluid in the secondary compartment to make a sound so that the container assembly also sounds like normal product container when shook. This will prevent users from finding the container containing a prize amongst a number of normal containers.

When a user opens the container by lifting the tab 18 as described above, he or she will see the notification means through the opening left by the downward movement of the break-out section 17. The user then removes the lid and the insert, or unscrews the insert out of the container body to reveal the prize below the insert in the main compartment.

It is envisaged that the container described herein will be convenient to use in a promotional exercise whereby prizes are randomly distributed in a selected number of containers. The container described herein will have a look and feel similar to the containers used for the distribution of the normal product.

The invention is not limited to precise details as herein described. Those skilled in the art will appreciate that many other embodiments are possible without departing from the scope of the invention.

1. A container assembly comprising a container body defining a main compartment; a hollow insert located in the main compartment to form a secondary compartment within the main compartment; the secondary compartment having a closure means for sealing a liquid therein; and the container body having a lid to close the main compartment.

2. A container assembly as claimed in claim 1 in which the assembly includes locating means to locate the insert in the main compartment.

3. A container assembly as claimed in any one of the preceding claims in which the main compartment includes a sleeve insert.

4. A container assembly as claimed in claim 3 in which the sleeve insert is a split sleeve.

5. A container assembly as claimed in claim 4 in which the sleeve parts of the split sleeve are resiliently deformable.

6. A container assembly as claimed in any one of claim 3 in which the sleeve parts terminate in axially inwardly extending lips.

7. A container assembly as claimed in claim 3 in which the sleeve parts have screw thread formations extending from an inside surface of each part.

8. A container assembly as claimed in claim 1 in which the insert is cylindrical.

9. A container assembly as claimed in claim 2 in which the locating means is an outer screw thread on the insert for engagement with screw thread formations on a two part sleeve.

10. A container assembly as claimed in claim 2 in which the insert has two cylindrical sections, a first section having a larger diameter than a second section.

11. A container assembly as claimed in claim 10 in which the insert has a cylindrical operatively lower hollow section and a frusto conical operatively upper hollow section.

12. A container assembly as claimed in claim 11 in which the first cylindrical section of the insert is its engagement means for frictional engagement with an inwardly extending lip formation in which each part of a two part sleeve located in the compartment terminates.

13. A container assembly as claimed in claim 1 in which the container lid has a circumferentially extending slot for engagement with an upper edge of the container body.

14. A container assembly as claimed in claim 13 in which the upper edge of the container body is a right-circular upwardly extending rim section for engagement with the complementary shaped slot in the lid.

15. A container assembly as claimed in claim 1 in which the lid includes notification means.

16. A container assembly as claimed in claim 15 in which notification means is provided in the form of a sticker located under the lid on the closure means.

17. A container assembly as claimed in claim 1 in which the closure means of the insert is a disc.
